(19) United States
(12) Patent Application Publication
(10) Pub. No.: US 2026/0321537 A1
(43) Pub. Date: Oct. 15, 2026

(54) REMOTE-CONTROLLED BREAKER SWITCH ACTUATION DEVICE

(71) Applicant: Beau Hallavant, Batesville, IN (US)

(72) Inventor: Beau Hallavant, Batesville, IN (US)

(21) Appl. No.: 19/572,316

(22) Filed: Mar. 19, 2026

Related U.S. Application Data
(60) Provisional application No. 63/787,064, filed on Apr. 11, 2025.

(51) Int. Cl. H01H 71/52; H01H 71/56; H02J 13/10; H02J 13/13; H02J 13/34

(52) U.S. Cl. CPC H01H 71/52; H01H 71/56; H02J 13/10; H02J 13/1333; H02J 13/34; H01H 2071/565

(57) ABSTRACT

The device is configured to remotely actuate a breaker switch. The device is comprised of a base having a rear mounting surface configured to attach to an exterior surface of a breaker panel via a fastener. An arm extends outward from the base in a cantilevered configuration and terminates at a receiving structure configured to contact and engage a breaker switch. The receiving structure is configured to align with breaker switch geometries and may further be comprised of a secondary fastener configured to maintain engagement with the breaker switch during actuation. A motorized articulation point is configured to generate controlled mechanical movement of the arm to move the breaker switch between on and off positions. The device is further comprised of a wireless transmitter configured to communicate with a mobile application. A microcontroller receives remote commands from the mobile application and directs movement of the arm between switching positions.

### CROSS-REFERENCE TO RELATED APPLICATION

The present application claims priority to, and the benefit of, U.S. Provisional Application No. 63/787,064, which was filed on Apr. 11, 2025, and is incorporated herein by reference in its entirety.

### FIELD OF THE INVENTION

The present invention relates generally to the field of electrical breakers. More specifically, the present invention relates to a device configured to remotely actuate a breaker switch through mechanical movement generated by a motorized arm that engages the breaker switch and moves the switch between on and off positions. Accordingly, the present disclosure makes specific reference thereto. Nonetheless, it is to be appreciated that aspects of the present invention are also equally applicable to other like applications, devices, and methods of manufacture.

### BACKGROUND

Electrical breaker panels are installed in residential, commercial, and industrial buildings to control the delivery of electrical power to individual circuits. During renovation, maintenance, troubleshooting, or installation activities, individuals frequently need to deactivate and reactivate electrical circuits through the breaker panel. In many buildings, breaker panels are located in remote areas such as basements, garages, mechanical rooms, closets, or exterior utility enclosures. When a person is actively working on a project in a different location, repeated travel between the work area and the breaker panel becomes necessary to toggle a breaker switch. This repeated movement can interrupt workflow and increase the time required to complete electrical tasks. In some situations, individuals may attempt to avoid these repeated trips by working on circuits that remain energized. Working on live electrical circuits introduces safety risks including electrical shock, equipment damage, and unintended circuit activation. Existing breaker panels generally require direct manual interaction with the breaker switches and do not provide a convenient method for remote mechanical actuation. While some electrical systems provide centralized control solutions, such systems often require complex installation or replacement of existing infrastructure. As a result, a need exists for a device that enables a user to remotely actuate a breaker switch without requiring direct access to the breaker panel.

Therefore, there exists a long-felt need in the art for a device that allows a user to remotely actuate a breaker switch without requiring physical access or proximity to a breaker panel. There also exists a long-felt need in the art for a remote-controlled breaker switch actuation device that can be mounted to an existing breaker panel and mechanically engage a breaker switch to toggle between on and off positions. Moreover, there exists a long-felt need in the art for a remote-controlled breaker switch actuation device that allows remote control of breaker switch actuation through a mobile application executed on a smart device.

The subject matter disclosed and claimed herein, in one embodiment thereof, comprises a remote-controlled breaker switch actuation device. The device is configured to remotely actuate a breaker switch positioned within a breaker panel. The device comprises a base having a rear mounting surface configured for attachment to an exterior surface of a breaker panel through at least one fastener. An arm extends outward from the base in a cantilevered configuration and terminates at a receiving structure configured to contact and engage a breaker switch. The receiving structure is adapted to align with breaker switch geometries and may include a secondary fastener configured to maintain engagement with the breaker switch during actuation. A motorized articulation point generates controlled mechanical movement of the arm to move the breaker switch from on and off positions. A wireless transmitter places the remote-controlled breaker switch actuation device in communication with a mobile application, wherein a microcontroller of the device is configured to receive remote commands from the application and generate control signals directing movement of the arm between switching positions.

In this manner, the remote-controlled breaker switch actuation device of the present invention accomplishes all the foregoing objectives and provides a device enabling a user to remotely actuate a breaker switch without requiring physical access to a breaker panel. The mounting structure further allows the device to be installed on an existing breaker panel without modification of electrical infrastructure. The motorized articulation system and receiving structure further provide reliable mechanical engagement with the breaker switch to move the switch between on and off positions. In addition, wireless communication with a mobile application enables a user to control electrical circuit activation from a remote location while working on a project. As a result, the device reduces the need for repeated travel between a work area and a breaker panel and improves workflow efficiency by making it easier to deactivate circuits prior to performing electrical work.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remote-controlled breaker switch actuation device. The device is configured to remotely switch a breaker switch on and off to eliminate the requirement of physical presence at a breaker panel to do the same. The device is configured for surface mounting onto an existing breaker panel to mechanically actuate a breaker switch between on and off positions through remote control via a mobile application. As such, the device allows a user to control electrical power delivery to a circuit without direct physical access to the breaker panel.

The device is comprised of a base further comprised of a rear mounting surface configured to engage an exterior surface of a breaker panel. The rear mounting surface may be planar or contoured to improve surface engagement with the breaker panel. The rear mounting surface is comprised of at least one fastener configured to attach the base to the exterior surface of the breaker panel.

The device is further comprised of at least one arm extending from the base. The arm may extend outward in a cantilevered configuration and is comprised of a receiving structure positioned at a distal end of the arm. The receiving structure is configured to contact and engage a breaker switch and may be shaped or contoured to align with breaker switch geometry to transfer mechanical force during actuation.

In one embodiment, the receiving structure may further be comprised of a contact layer configured to improve grip between the receiving structure and the breaker switch. The receiving structure may also be further comprised of a secondary fastener configured to secure engagement between the receiving structure and the breaker switch.

The arm is movable through a motorized articulation configured to convert electrical input signals into controlled mechanical motion of the arm. The articulation point may further include a torque amplification system configured to generate sufficient force to actuate breaker switches requiring higher switching resistance. The articulation point may further include position sensors to detect positional states of the arm corresponding to on or off positions of the breaker switch.

The device is comprised of a wireless transmitter configured to enable wireless communication between the device and a mobile application installed on a smart device. The wireless transmitter may further include an antenna configured to enhance signal strength and communication reliability. The device is further comprised of a microcontroller configured to process wireless commands and control the motorized articulation point in response to user input from the mobile application. The mobile application is comprised of a control interface presented on a graphical display of a smart device. The control interface is comprised of one or more controls such as a virtual button configured to allow a user to command movement of the articulation point, thereby moving the arm to switch the breaker switch between on and off positions.

Accordingly, the remote-controlled breaker switch actuation device of the present invention is particularly advantageous as it provides a device enabling a user to remotely actuate a breaker switch without requiring physical access to a breaker panel. The mounting structure further allows the device to be installed on an existing breaker panel without modification of electrical infrastructure. The motorized articulation system and receiving structure further provide reliable mechanical engagement with the breaker switch to move the switch between on and off positions. In addition, wireless communication with a mobile application enables a user to control electrical circuit activation from a remote location while working on a project. As a result, the device reduces the need for repeated travel between a work area and a breaker panel and improves workflow efficiency by making it easier to deactivate circuits prior to performing electrical work.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a remote-controlled breaker switch actuation device of the present invention in accordance with the disclosed architecture;

FIG. 2 illustrates a perspective view of one potential embodiment of a remote-controlled breaker switch actuation device of the present invention in accordance with the disclosed architecture;

FIG. 3 illustrates a front perspective view of one potential embodiment of a remote-controlled breaker switch actuation device of the present invention while attached to a breaker panel and breaker switch in accordance with the disclosed architecture; and

FIG. 4 illustrates a front view of a mobile application of one potential embodiment of a remote-controlled breaker switch actuation device of the present invention while installed on a smart device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to remotely actuate a breaker switch without requiring physical access or proximity to a breaker panel. There also exists a long-felt need in the art for a remote-controlled breaker switch actuation device that can be mounted to an existing breaker panel and mechanically engage a breaker switch to toggle between on and off positions. Moreover, there exists a long-felt need in the art for a remote-controlled breaker switch actuation device that allows remote control of breaker switch actuation through a mobile application executed on a smart device.

The present invention, in one exemplary embodiment, is comprised of a remote-controlled breaker switch actuation device. The device is configured to remotely actuate a breaker switch positioned within a breaker panel. The device is comprised of a base having a rear mounting surface configured to attach to an exterior surface of a breaker panel through at least one fastener. An arm extends outward from the base in a cantilevered configuration and terminates at a receiving structure configured to contact and engage a breaker switch. The receiving structure is configured to align with breaker switch geometries and may further be comprised of a secondary fastener configured to maintain engagement with the breaker switch during actuation. A motorized articulation point is configured to generate controlled mechanical movement of the arm to move the breaker switch between on and off positions. The device is further comprised of a wireless transmitter configured to place the device in communication with a mobile application. A microcontroller of the device is configured to receive remote commands from the mobile application and generate control signals directing movement of the arm between switching positions.

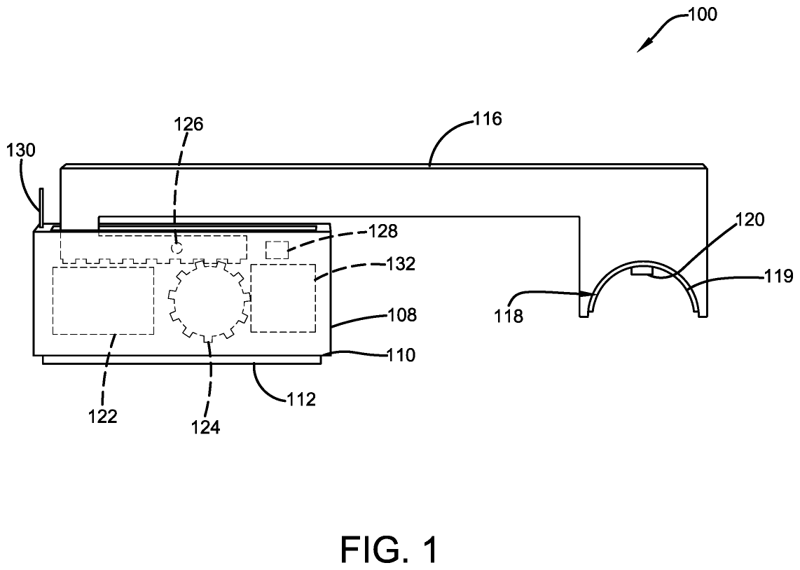

Referring initially to the drawings, FIG. 1 illustrates a side view of one potential embodiment of a remote-controlled breaker switch actuation device 100 of the present invention in accordance with the disclosed architecture. The device 100 is configured to remotely switch a breaker switch 104 on and off, thereby eliminating the need for a user to be physically present at a breaker panel 102 to do so. More specifically, the device 100 is configured to be surface-mounted onto an existing breaker panel 102 to mechanically actuate a breaker switch 104 between on and off positions via remote control through a mobile application 106. As such, the device 100 may allow a user to control electrical power delivery to a circuit without requiring direct physical access to the breaker panel 102, which may be located in a remote room, basement, garage, utility enclosure, mechanical room, or other installation environment.

The device 100 is comprised of a base 108. The base 108 may be rectangular in shape but may be any shape such as but not limited to square, circular, oval, trapezoidal, elongated, contoured, or irregular profiles configured to accommodate different breaker panel 102 geometries. The base 108 may further be comprised of a rear mounting surface 110. The rear mounting surface 110 may be generally planar but may also be slightly contoured to improve surface engagement with an exterior surface 114 of a breaker panel 102.

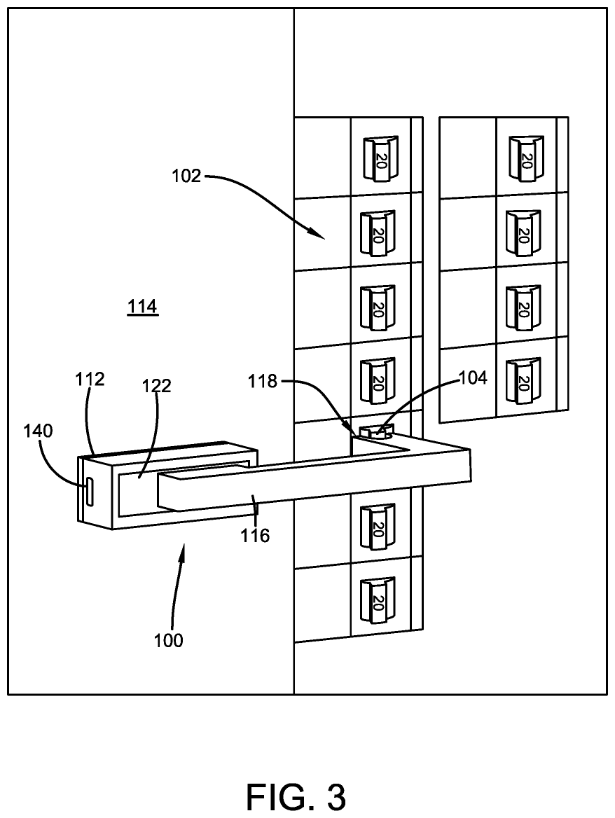

In one embodiment, the rear mounting surface 110 is comprised of at least one fastener 112 that allows the base 108 to attach to the exterior surface 114 of the breaker panel 102, as seen in FIG. 3. The fastener 112 may be comprised of any combination of an adhesive fastener, suction cup, magnetic fastener, mechanical clamp, mechanical clip, hook-and-loop fastener, threaded fastener, adjustable bracket, etc. The fastener 112 may be positioned at one or more locations across the rear mounting surface 110 to distribute mounting forces and maintain alignment of the base 108 relative to the breaker switch 104. In certain embodiments, multiple fasteners 112 may be used simultaneously to improve mounting stability and reduce movement of the device 100 during actuation.

At least one arm 116 extends from the base 108. The arm 116 may extend outward from the base 108 in a cantilevered configuration and may be curved, linear, stepped, angled, or segmented depending on the spatial relationship between the base 108 and the breaker switch 104. The arm 116 may be comprised of rigid or semi-rigid structural materials capable of withstanding repeated actuation forces.

The arm 116 is comprised of a receiving structure 118 positioned at a distal end of the arm 116, as seen in FIG. 1. The receiving structure 118 is configured to contact a breaker switch 104. The receiving structure 118 may be shaped or contoured to align with a geometry of the breaker switch 104 in order to transfer mechanical force efficiently during actuation. As such, the receiving structure 118 may be in the form of a concave recess, forked channel, contoured cavity, friction pad, elastomeric contact surface, adjustable jaw assembly, etc. such that the receiving structure 118 can receive and engage various breaker switch 104 styles such as but not limited to rocker-style breakers, toggle-style breakers, push-button breakers, and other breaker interface geometries commonly present within breaker panels 102.

In one embodiment, the receiving structure 118 may further be comprised of a contact layer 119 such as but not limited to rubber, silicone, thermoplastic elastomers, textured polymers, or other friction-enhancing materials configured to improve grip between the receiving structure 118 and the breaker switch 104. Such materials may reduce slippage and improve reliable force transmission during switching operations.

In one embodiment, the receiving structure 118 is further comprised of a secondary fastener 120 (as seen in FIG. 1) that is configured to secure engagement between the receiving structure 118 and the breaker switch 104. The secondary fastener 120 may be comprised of any combination of a clip, magnet, clamp, spring-biased retention member, flexible gripping tabs, snap-fit structure, hook element, etc. More specifically, the secondary fastener 120 may apply gripping force onto the breaker switch 104 to maintain engagement between the receiving structure 118 and the breaker switch 104 while the arm 116 moves between positions. The secondary fastener 120 may further enhance positional stability during actuation and may reduce slippage during vertical movement of the arm 116.

The arm 116 may be moved left and right via a motorized articulation point 122 (as seen in FIG. 1) such as but not limited to an electric motor, servo motor, stepper motor, linear actuator, solenoid-driven linkage, gear-driven pivot assembly, rack-and-pinion mechanism, worm gear assembly, etc. The motorized articulation point 122 is further configured to convert electrical input signals into controlled mechanical motion of the arm 116. The motorized articulation point 122 may also be comprised of a torque amplification system 124 such as but not limited to reduction gears, planetary gear sets, belt drives, or chain drives to generate sufficient mechanical force to actuate breaker switches 104 requiring higher switching resistance.

The articulation point 122 may further be comprised of position sensors 126 such as but not limited to limit switches, Hall-effect sensors, optical encoders, potentiometers, etc. The position sensors 126 may detect whether the arm 116 is in the left position or right position to confirm whether the breaker switch 104 is currently in the on or off position. The position sensors 126 may therefore provide positional feedback to the microcontroller 132 to ensure accurate switching and may allow the device 100 to verify successful actuation after a command has been executed.

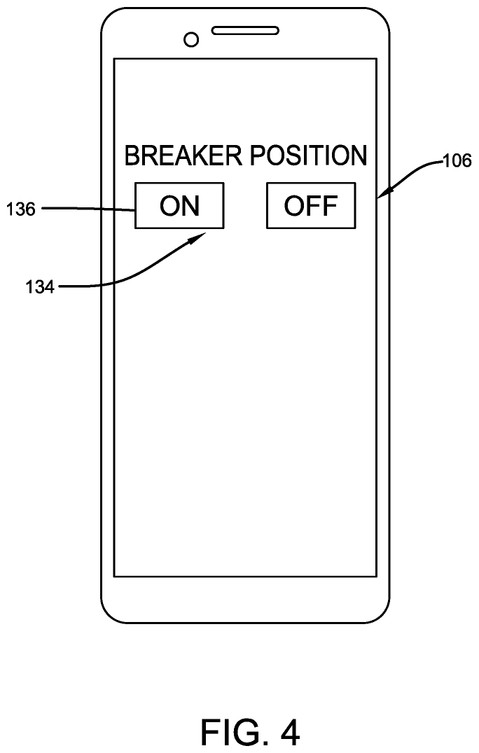

The device 100 is comprised of a wireless transmitter 128 that allows the device 100 to be placed in wireless communication with a mobile application 106 installed on a smart device, as seen in FIG. 4. The wireless transmitter 128 may be a communication module such as but not limited to Wi-Fi module, Bluetooth module, cellular communication module, Zigbee module, Z-Wave module, near-field communication interface, etc. The wireless transmitter 128 may allow the device 100 to receive commands from a remote location and may allow the device 100 to transmit operational information back to the mobile application 106. In one embodiment, the wireless transmitter 128 may be comprised of an antenna 130 to enhance signal strength and improve communication reliability. The antenna 130 may be an internal antenna or an external antenna integrated into the housing of the base 108.

The device 100 may further be comprised of a microcontroller 132 configured to process wireless commands and control the motorized articulation point 122 in response to user input on the application 106. The microcontroller 132 may be comprised of a programmable processing unit capable of executing control instructions stored in memory. The microcontroller 132 may interpret signals received by the wireless transmitter 128 and may generate corresponding control signals that drive the motorized articulation point 122 to move the arm 116 into the desired position.

The mobile application 106 is comprised of a control interface 134 that may be in the form of one or more controls 136 such as a virtual button, as seen in FIG. 4. The control interface 134 may be displayed on a graphical display of a smart device such as but not limited to a smartphone, tablet, wearable device, or other computing device capable of running the mobile application 106. Interacting with the control 136 allows a user to configure the articulation point 122 such that the arm 116 is moved left or right to thus switch the breaker switch 104 into an on or off position.

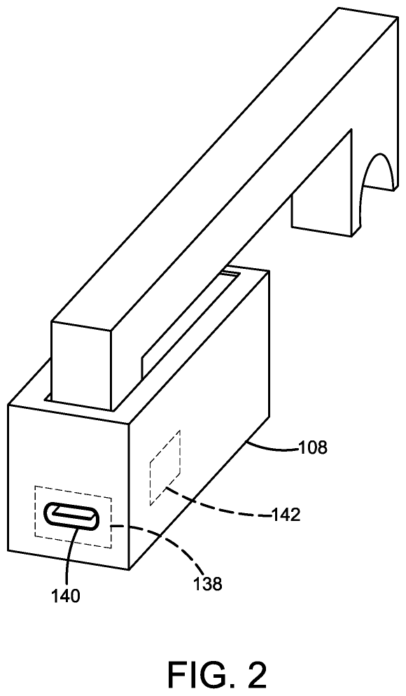

The device 100 is also comprised of a battery 138, as seen in FIG. 2. The battery 138 may be comprised of a rechargeable battery such as but not limited to lithium-ion, lithium polymer, nickel-metal hydride, etc., or a replaceable battery pack. The battery 138 may also be a disposable battery. The battery 138 may provide electrical power to the motorized articulation point 122, wireless transmitter 128, microcontroller 132, and associated electronic components within the device 100. In one embodiment, the device 100 is comprised of a charging port 140 such as but not limited to USB port, USB-C port, barrel connector, magnetic charging interface, inductive charging coil, etc. The charging port 140 may allow the battery 138 to be recharged using an external power source.

The device 100 may further be comprised of a power management circuit 142 configured to regulate voltage, prevent overcharging, monitor battery health, and optimize energy consumption. The power management circuit 142 may distribute electrical power from the battery 138 to electronic components within the device 100 while maintaining stable voltage levels and protecting the battery 138 from conditions such as over-discharge or excessive charging current.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “remote-controlled breaker switch actuation device” and “device” are interchangeable and refer to the remote-controlled breaker switch actuation device 100 of the present invention.

Notwithstanding the foregoing, the remote-controlled breaker switch actuation device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the remote-controlled breaker switch actuation device 100 as shown in the FIGS. are for illustrative purposes only, and that many other sizes and shapes of the remote-controlled breaker switch actuation device 100 are well within the scope of the present disclosure. Although the dimensions of the remote-controlled breaker switch actuation device 100 are important design parameters for user convenience, the remote-controlled breaker switch actuation device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote-controlled breaker switch actuation device comprising:
a base further comprising a rear mounting surface;
a fastener positioned on the rear mounting surface;
an arm extending from the base;
a receiving structure positioned at a distal end of the arm;
a motorized articulation point coupled to the arm and configured to move the arm between a first position and a second position;
a wireless transmitter; and
a battery.

2. The remote-controlled breaker switch actuation device of claim 1, wherein the rear mounting surface is planar.

3. The remote-controlled breaker switch actuation device of claim 1, wherein the arm is curved.

4. The remote-controlled breaker switch actuation device of claim 1, wherein the fastener is comprised of a magnetic fastener.

5. A remote-controlled breaker switch actuation device comprising:
a base further comprising a rear mounting surface;
a fastener positioned on the rear mounting surface;
an arm extending from the base;
a receiving structure positioned at a distal end of the arm;
a motorized articulation point coupled to the arm and configured to move the arm between a first position and a second position;
a torque amplification system;
a wireless transmitter;
a battery; and
a charging port.

6. The remote-controlled breaker switch actuation device of claim 5, wherein the rear mounting surface is contoured.

7. The remote-controlled breaker switch actuation device of claim 5 further comprising a position sensor.

8. The remote-controlled breaker switch actuation device of claim 5 further comprising an antenna.

9. The remote-controlled breaker switch actuation device of claim 5, wherein the receiving structure is comprised of a contact layer.

10. The remote-controlled breaker switch actuation device of claim 5, wherein the receiving structure is comprised of a secondary fastener.

11. The remote-controlled breaker switch actuation device of claim 5 further comprising a power management circuit.

12. A remote-controlled breaker switch actuation device comprising:
a base further comprising a rear mounting surface;
a fastener positioned on the rear mounting surface;
an arm extending from the base;
a receiving structure positioned at a distal end of the arm;
a motorized articulation point coupled to the arm and configured to move the arm between a first position and a second position;
a torque amplification system;
a wireless transmitter;
a battery;
a charging port; and
a mobile application configured to control the motorized articulation point.

13. The remote-controlled breaker switch actuation device of claim 12 further comprising a position sensor.

14. The remote-controlled breaker switch actuation device of claim 12 further comprising an antenna.

15. The remote-controlled breaker switch actuation device of claim 12, wherein the receiving structure is comprised of a contact layer.

16. The remote-controlled breaker switch actuation device of claim 12, wherein the receiving structure is comprised of a secondary fastener.

17. The remote-controlled breaker switch actuation device of claim 12 further comprising a power management circuit.

18. The remote-controlled breaker switch actuation device of claim 12, wherein the mobile application is comprised of a control.

19. The remote-controlled breaker switch actuation device of claim 12, wherein the battery is comprised of a rechargeable battery.

20. The remote-controlled breaker switch actuation device of claim 12, wherein the rear mounting surface is planar or contoured.
